(19) United States
(12) Patent Application Publication
(10) Pub. No.: US 2024/0105439 A1
(43) Pub. Date: Mar. 28, 2024

(54) Mass and Kinetic Energy Ordering of Ions Prior to Orthogonal Extraction Using Dipolar DC

(71) Applicant: DH Technologies Development Pte. Ltd., Singapore (SG)

(72) Inventor: Eric Thomas DZIEKONSKI, Concord (CA)

(73) Assignee: DH Technologies Development Pte. Ltd., Singapore (SG)

(21) Appl. No.: 18/276,172

(22) PCT Filed: Feb. 4, 2022
(86) PCT No.: PCT/IB2022/051008

§ 371 Date: Aug. 7, 2023

Related U.S. Application Data
(60) Provisional application No. 63/147,045, filed on Feb. 8, 2021.

(51) Int. Cl. H01J 49/42

(52) U.S. Cl. CPC H01J 49/423; H01J 49/427

(57) ABSTRACT

In one aspect, a mass spectrometer is disclosed, which comprises an ion trap having a plurality of electrodes arranged in a multipole configuration so as to provide an inlet for receiving ions along a longitudinal axis into a space between the electrodes, where at least one of the plurality of electrodes comprises a passageway through which ions can be extracted radially from the ion trap. The electrodes are configured for application of one or more RF voltages thereto for providing radial confinement of the ions, and a DC voltage source configured to apply a dipolar DC voltage pulse across said at least one electrode and an opposed electrode for causing radial extraction of at least a portion of said ions from said ion trap through said passageway.

### RELATED APPLICATIONS

The present application claims priority to U.S. Provisional Application No. 63/147,045 filed on Feb. 8, 2021, entitled “Mass and Kinetic Energy Ordering of Ions Prior to Orthogonal Extraction Using Dipolar DC,” which is incorporated herein by reference in its entirety.

### BACKGROUND

The present teachings are related to an ion trap that can be utilized in a variety of mass spectrometers, as well as mass spectrometers in which such an ion trap can be incorporated.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

In some mass spectrometers, an electrostatic linear ion trap (ELIT) is employed for detecting ions generated by an upstream ion source. Typically, an RF ion guide is positioned between the ion source and the ELIT for guiding (e.g., focusing) the ions into the ELIT. However, the injection of ions into an electrostatic ion trap (analyzer) from an RF ion guide generally leads to the capture of ions having a limited m/z range due to time-of-flight effects during the injection step.

Accordingly, there is a need for enhanced ion traps and particularly for enhanced ion traps that can be used for injection of ions into an ELIT.

### SUMMARY

In one aspect, a mass spectrometer is disclosed, which comprises an ion trap having a plurality of electrodes arranged in a multipole configuration so as to provide an inlet for receiving ions along a longitudinal axis into a space between the electrodes, where at least one of the plurality of electrodes comprises a passageway through which ions can be extracted radially from the ion trap. The electrodes are configured for application of one or more RF voltages thereto for providing radial confinement of the ions, and a DC voltage source configured to apply a dipolar DC voltage pulse across said at least one electrode and an opposed electrode for causing radial extraction of at least a portion of said ions from said ion trap through said passageway.

In some embodiments, an ELIT is positioned downstream of the ion trap for receiving and detecting at least a portion of the ions extracted from said ion trap. In some embodiments, the ELIT can include at least two ion mirrors each of which is disposed at one end of the ELIT for axially trapping the received ions in a space therebetween. Each ion mirror can deflect the ions incident thereon toward the opposed ion mirror.

The ELIT can further include an electric charge detector that is disposed between the two ion mirrors for detecting the ions. In some such embodiments, the electric charge detector can include a substantially cylindrical electrode that surrounds at least a portion of the space between the ion mirrors such that the passage of the ions through the cylindrical electrode induces electric charge on the electrode. In some embodiments, a detection circuitry coupled to the electrode can receive the charge induced on the electrode and generate one or more ion detection signals based on the induced electric charge. An analysis module (herein also referred to as an analyzer) that is in electrical communication with the detection circuitry can in turn receive the ion detection signals and operate on those signals to generate a mass spectrum of the ions. In some embodiments, the analysis module is configured to apply a Fourier Transform to the detection signals to generate a mass spectrum of the ions received by the ELIT.

The dipolar voltage pulse can facilitate mass-ordered radial offset of the ions within the trap. The application of a DC extraction voltage, e.g., to the electrode in which the ion passageway is provided, can cause extraction of the mass-ordered ions from the ion trap. The radial mass ordering of the ions results in a difference in the kinetic energy of the ions extracted from the ion trap as the ions that are positioned farther from the inlet of the passageway through which ions are extracted from the ion trap will be accelerated more than those ions that are positioned closer to the passageway inlet.

In some embodiments, such a difference in the ions' kinetic energy allows the ions extracted later to catch up with those that are extracted earlier. For example, in some embodiments, such a spread in the ions' kinetic energy can result in low m/z ions, which are extracted later than higher m/z ions, catching up with higher m/z ions. In some other embodiments, the spread in the ions' kinetic energy can result in high m/z ions catching up with the lower m/z ions.

In some embodiments, the polarity of the applied dipolar voltage pulse is configured/selected such that the ions are extracted from the ion trap in a high mass to low mass order. Alternatively, in some embodiments, the polarity of the dipolar voltage pulse can be configured/selected such that the ions are extracted from the ion trap in a low-mass to high-mass order.

In some embodiments, the multipole configuration of the ion trap can be in the form of a quadrupole configuration. In other embodiments, the ion trap can include a plurality of rods arranged in other multipole configurations, e.g., a hexapole or an octupole configurations.

In some embodiments, one or more RF voltages applied to the electrodes of the ion trap can have a frequency in a range of about 0.1 MHz to about 5 MHz and an amplitude (e.g., a zero-to-peak amplitude) in a range of about 100 volts to about 1000 volts. Further, in some embodiments, the dipolar voltage pulse can have an amplitude in a range of about 25 volts to about 500 volts.

In a related aspect, an ion trap is disclosed, which comprises a plurality of electrodes configured in a multipole configuration so as to provide an inlet through which ions can enter a space between the electrodes, wherein one of the electrodes comprises a passageway through which ions can be radially extracted from said ion trap, and a DC voltage source for applying a dipolar DC voltage pulse across said electrode having the passageway and an opposed electrode for causing radial offset of said ions.

In a related aspect, a method of performing mass spectrometry is disclosed, which comprises introducing a plurality of ions into an ion trap comprising a plurality of electrodes arranged in a multipole configuration, where one of those electrodes includes a passageway for radial extraction of the ions from the ion trap, applying one or more RF voltages to one or more of said electrodes to generate an electromagnetic field for radially confining the ions within the ion trap, and applying a DC dipolar voltage pulse across said electrode having the passageway and an opposed electrode so as to provide radial offset of at least a portion of the ions. An extraction DC voltage can then be applied to extract at least some of the ions from the ion trap. In many embodiments, the radial offset of the ions caused by the application of the DC dipolar voltage results in a mass-ordered radial distribution of the ions such that the higher mass ions are closer to the electrode having an attractive polarity (e.g., a negative polarity with the ions have a positive charge).

In some embodiments, the polarity of the DC dipolar voltage pulse is selected such that the ions are radially arranged (e.g., radially offset relative to the ion trap's center) in a high to low mass order. In some other embodiments, the polarity of the DC dipolar voltage pulse is selected such that the ions are radially arranged in the ion trap in a low to high mass order.

Subsequent to the application of the dipolar DC voltage pulse, the application of an extraction voltage (e.g., a DC extraction voltage) can cause the extraction of the ions from the ion trap. In some embodiments, a mass analyzer (e.g., ELIT) positioned downstream of the ion trap can receive the extracted ions and provide mass analysis thereof. In some related aspects, the ions introduced into the ELIT may be axially trapped therewithin. Additionally, in some aspects, an electric charge detector incorporated in the ELIT can detect said axially trapped ions. In many such embodiments, the dipolar DC voltage, the extraction voltage as well as the separation between the ion trap and the downstream mass analyzer are selected such that the extracted ions arrive substantially concurrently at the downstream mass analyzer. By way of example, such substantially concurrent arrival of the extracted ions at the mass analyzer can result in the mass analyzer containing ions spanning an m/z range of at least 2000, e.g., an m/z range of about 400 to about 6000. This can in turn allow a much more efficient mass analysis of the ions.

In a related aspect, an ion trap is disclosed, which includes a plurality of electrodes configured in a multipole configuration, e.g., a quadrupole configuration, so as to provide an inlet through which ions can enter a space between said electrodes, wherein one of said electrodes comprises a passageway through which ions can be radially extracted from said ion trap, and a DC voltage source for applying a dipolar DC voltage pulse to said electrode having the passageway and an opposed electrode for causing radial offset of said ions.

Further understanding of various aspects of the present teachings can be obtained by reference to the following detailed description in conjunction with the associated drawings, which are described briefly below.

### BRIEF DESCRIPTION OF THE DRAWINGS

FIG. 1 is a schematic end view of an ion trap according to an embodiment of the present teachings,

FIG. 2 is a schematic side view of the ion trap illustrated in FIG. 1,

FIG. 3 schematically depicts the movement of ions toward one of the electrodes of the ion trap depicted in FIGS. 1 and 2, in which a channel for transmission of ions to the external environment is provided, in response to the application of a dipolar DC voltage pulse across that electrode and an opposed electrode,

FIG. 4 schematically depicts an electrostatic linear ion trap (ELIT) that can be positioned downstream of an ion trap according to an embodiment of the present teachings,

FIG. 5A schematically depicts an embodiment of an ion trap according to the present teachings in which the polarity of dipolar voltage pulse applied across two electrodes of the ion trap is such that the ions with low m/z ratios exit the ion trap prior to ions with higher m/z ratios,

FIG. 5B schematically depicts the radial extraction of ions from the ion trap shown in FIG. 5A,

FIG. 6A schematically shows that at very high extraction voltages, the high m/z ions exiting the trap after the low m/z ions will catch up with the lower m/z ions after a given travel distance,

FIG. 6B schematically shows that at very low extraction voltages, the ions extracted from the ion trap continue to expand,

FIG. 6C schematically depicts the lower m/z ions extracted from the ion trap, after the higher m/z ions, will catch up with ions having the higher m/z after traveling a certain distance,

FIG. 7 schematically illustrates the injection of ions extracted from the ion trap depicted in FIGS. 5A-5B into a downstream ELIT results in a greater penetration of the high m/z ions relative to lower m/z ions into the ion mirrors of the ELIT, and

FIG. 8 schematically depicts a mass spectrometer according to an embodiment of the present teachings.

### DETAILED DESCRIPTION

The present teachings are generally directed to an ion trap that can be employed in a mass spectrometer. In some embodiments, such an ion trap allows radial extraction of ions within the trap in a mass-ordered fashion such that the extracted ions can substantially concurrently arrive at a downstream mass analyzer, e.g., an electrostatic linear ion trap. Various terms are used herein in accordance with their ordinary meanings in the art. The term “about” as used herein indicates a variation of at most 10% around a numerical value. And the term “substantially” as used herein indicates a maximum deviation from a complete state and/or condition of at most 10%.

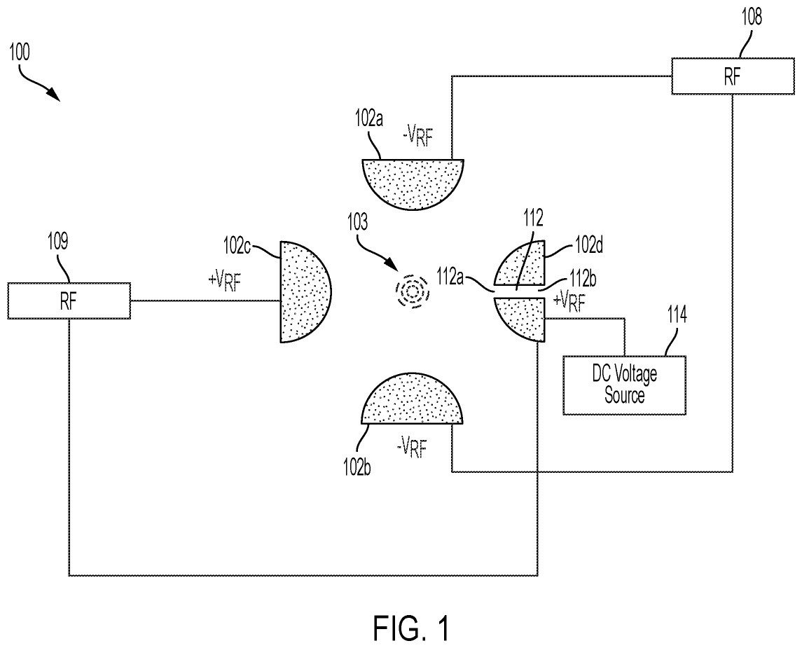

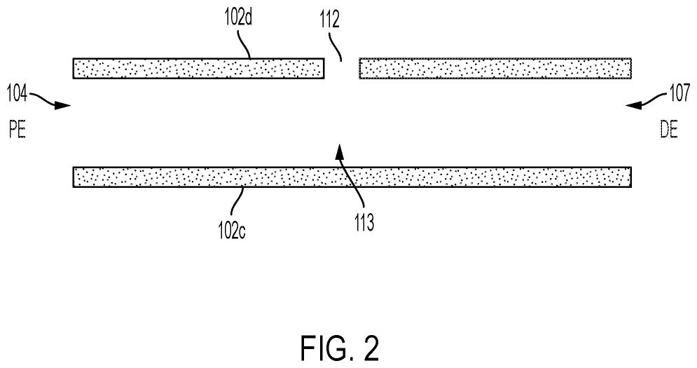

FIGS. 1 and 2 schematically depict an ion trap 100 according to an embodiment of the present teachings, which includes a plurality of electrodes 102a, 102b, 102c, and 102d, which are herein referred to collectively as electrodes 102 and which are in the form of a plurality of rods in this embodiment. The electrodes 102 extend from a proximal end (PE) to a distal end (DE) and are arranged in a quadrupole configuration relative to one another to provide an inlet 104, through which ions generated by an upstream ion source (not shown in this figure) enter the ion trap (i.e., the ions can enter a space between the electrodes), and an outlet 107 through which ions can exit the ion trap. Although in this embodiment the electrodes 102 are arranged in a quadrupole configuration, in other embodiments, the electrodes 102 can be arranged in other multipole configurations, e.g., a hexapole or an octupole configuration.

In this embodiment, two RF (radiofrequency) sources 108/109 apply RF signals to each pair of the electrodes such that the RF signal applied across the electrode pair (102a, 102b) has an opposite phase relative to the RF signal applied across the electrode pair (102c,102d). In some embodiments, the frequency of the applied RF signals can be, for example, in a range of about 0.1 MHz to about 5 MHz, e.g., in a range of about 1 MHz to about 4 MHz, and the amplitude of the applied RF signals can be, for example, in a range of about 100 volts to about 1000 volts, though other frequencies and voltages can also be employed.

The application of the RF signals to the electrodes results in generation of an electromagnetic field within the space 103 between the electrodes, where the electromagnetic field provides radial confinement of the ions within that space.

With particular reference to FIG. 1, in this embodiment, the electrode 102d includes a channel 112 that connects the space between the electrodes to the external environment and through which ions can be radially extracted from the ion trap, as discussed in more detail below. In some embodiments, the channel 112 can have a substantially cylindrical profile extending between an inlet 112a through which ions can enter the channel to an outlet 112b through which ions can exit the channel. By way of example, in some embodiments, the channel 112 can have a diameter in a range of about 0.5 to about 2 mm and a length in a range of about 0.1 and 1 cm, though other diameters and lengths can also be employed.

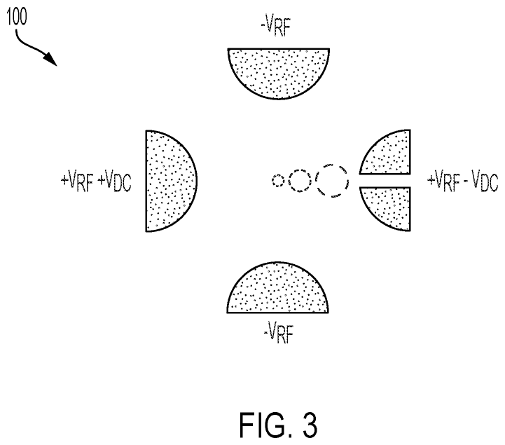

A DC voltage source 114 can apply a dipolar DC voltage pulse across the electrodes 102c and 102d to move the ions off-center and allow their radial extraction through the channel 112. In the embodiment depicted in FIG. 3, the polarity of the applied dipolar voltage is such that the electrode 102d is maintained at a more attractive electric potential relative to the electrode 102c. As the radial confinement of ions with a higher mass is less restrictive relative to the radial confinement of lower mass ions, the ions having higher m/z ratios move farther off-center toward the attractive potential (in this embodiment, the ions are assumed to be positive, and hence they are attracted to the more negative electrode 102d.

The DC voltage source 114 can apply an extraction “pull” pulse to the electrode 102d, or alternatively, or in addition, an extraction “push” pulse to the electrode 102c, to accelerate the ions toward the channel 112 and cause transmission of at least a portion of the ions through the channel 112 to the external environment. In other words, the DC voltage source 114 can apply an attractive extraction DC voltage only to the electrode 102d to attract (i.e., pull) the ions toward the channel 112 formed in the electrode 102d, or the DC voltage source can apply a repulsive extraction DC voltage only to the electrode 102c to repel the ions toward the electrode 102d (i.e., push the ions toward the electrode 102d), or both.

As in this embodiment the higher m/z ions will be closer to the inlet 112a of the channel 112 than lower m/z ions, the ions transmitted through the channel 112 exhibit an approximate mass ordering with the higher m/z ions exiting the ion trap before the lower m/z ions. However, the lower m/z ions will be accelerated to a greater kinetic energy than the higher m/z ions as the lower m/z ions experience the electric field established by the extraction electrode over a longer path.

Thus, although the higher m/z ions exit the ion trap prior to the lower m/z ions, given sufficient time (distance), the lower m/z ions can catch up with the higher m/z ions.

As discussed in more detail below, in some embodiments in which an electrostatic linear ion trap (ELIT) is positioned downstream of the ion trap, the distance between the ion trap and the ELIT, the dipolar DC voltage pulse, as well as the DC extraction voltage are selected to ensure that the extracted ions arrive substantially concurrently at the ELIT, preferably at the center of ELIT.

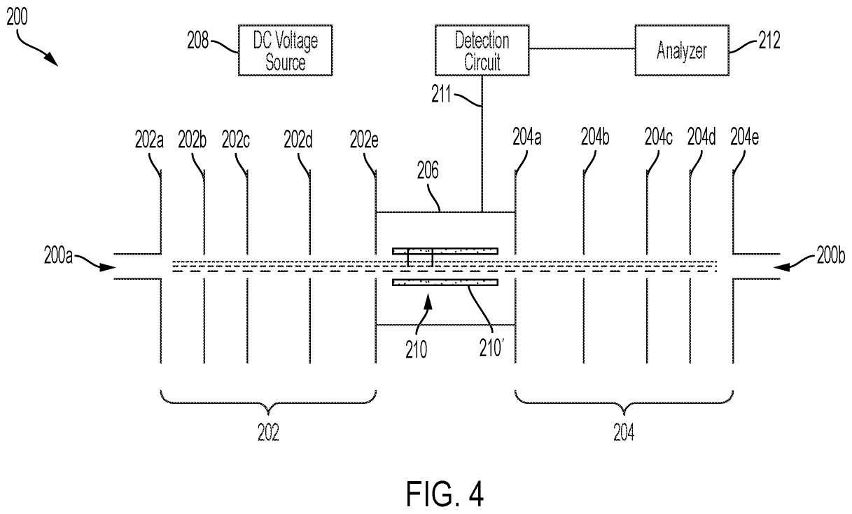

More specifically, with reference to FIG. 4, in some embodiments, an ELIT 200 is positioned downstream of the ion trap 100 to receive the ions ejected from the ion trap, as discussed above. The illustrated ELIT 200 includes an inlet 200a through which ions can enter the ELIT 200 and an outlet 200b through which ions can exit the ELIT 200. The ELIT 200 further includes a proximal set of ion mirrors 202 and a distal set of ion mirrors 204 between which an ion detector 210, enclosed in a housing 206 which shields the detector from external pulsed voltages, is positioned. Though not shown in this figure, other components of the ELIT 200 are also positioned within a housing. In some embodiments, the housing can be maintained at a pressure lower than the atmospheric pressure, e.g., a pressure in a range of about 1E-9 to about 1E-11 Torr.

In this embodiment, the proximal set of ion mirrors 202 includes five electrodes 202a, 202b, 202c, 202d, and 202e, each of which includes an opening through which the ions can pass. Similarly, the distal set of ion mirrors 204 includes five electrodes 204a, 204b, 204c, 204d, and 204e, each of which includes an opening through which the ions can pass.

At least one DC voltage source 208 applies DC voltages to the electrodes of the proximal and the distal sets of the ion mirrors 202/204 so as to axially trap the ions received by the ELIT between these two sets of the ion mirrors. In general, the magnitude and the polarity of DC voltages depend, for example, on the final kinetic energy (KE) and the charge polarity of the ions. By way of example, in some embodiments, the DC voltages applied to the ion mirrors can range from −6 kV to about +6 kV.

In this embodiment in which the polarity of the dipolar voltage pulse causes the low m/z ions to have a greater kinetic energy than the high m/z ions, the low m/z ions penetrate deeper into each ion mirror before being deflected back to the opposed ion mirror than the high m/z ions. This m/z dependence of the turning points within the ion mirrors can advantageously reduce the charge density near the turning points. Among other advantages, the reduction of the charge density near the turning points can reduce the likelihood that artefacts such as peak-splitting, peak coalescence appear in the resultant mass spectrum.

Depending on the type of the electrostatic trap, the magnitude of the dipolar DC voltage pulse, the magnitude of the extraction field, and the m/z range of interest, broad kinetic energy range ion mirrors can be required. A typical m/z range can be 200-2000. Typically, the kinetic energy range of reflectrons, i.e., the kinetic energy range over which nearly isochronous motion can be achieved, is only in the range of 1-10's of eV. In contrast, broad kinetic energy mirrors can effectively focus ions with 100's to 1000's of eV energy difference, though they may not provide perfect isochronous motion.

In this embodiment, the ion detector 210 includes a cylindrical electrode 210′ that surrounds a portion of the passageway through which ions propagate between the two sets of ion mirrors 202/204. The passage of the ions through the cylindrical electrode 210′ can induce an electric charge on the cylindrical electrode. A detection circuit 211 can detect the induced electric charge and generate one or more detection signals. An analyzer 212 in communication with the detection circuit 211 can receive the detection signals and operate on those detection signals to generate a mass spectrum of the ions trapped in the ELIT.

More specifically, the transit time of ions through the cylindrical electrode can be related to their mass (e.g., inversely related to the square root of the ions mass-to-charge ratio). The variation of the transit time of the ions will be manifested in time variation of the detected ion signal. In many embodiments, the time-varying signal is recorded for a specified period of time and the analyzer 212 obtains a Fourier Transform of the recorded time-varying signal. The detected frequencies in the resulting spectrum are inversely proportional to the square root of the ions' m/z ratios.

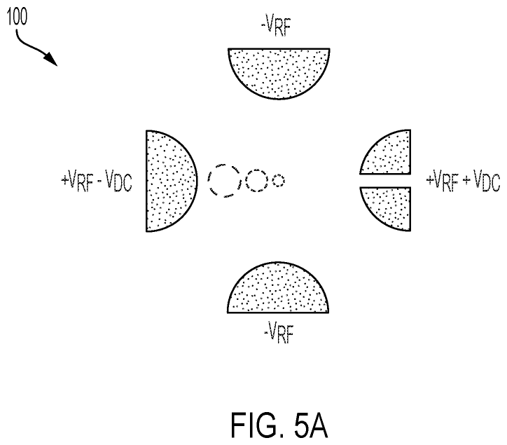

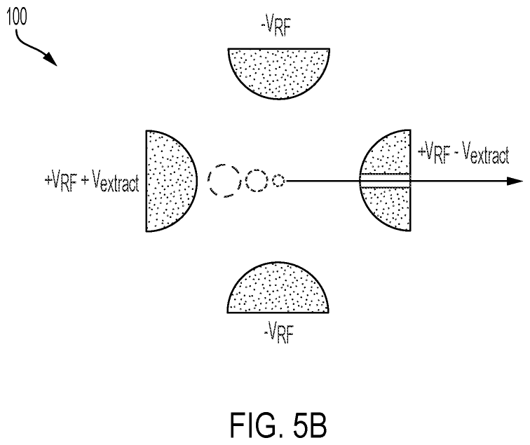

FIGS. 5A-5B show an embodiment in which the polarity of the dipolar voltage pulse applied across the electrodes 102c/102d is opposite to the polarity of the dipolar voltage pulse that is applied across those electrodes in the above embodiment. More specifically, in this embodiment, the polarity of the applied dipolar voltage pulse is such that the electrode 102c is maintained at a negative electric potential relative to the electrode 102d. Thus, in this embodiment, the electric field generated by the dipolar voltage pulse causes the higher m/z ions, which have a larger radial extension than lower m/z ions, to be moved closer to the electrode 102c than the lower m/z ions (again, it is assumed the ions have a positive charge). Hence, in this embodiment, the lower m/z ions exit the ion trap 100 prior to the higher m/z ions. But the higher m/z ions will be accelerated to a greater kinetic energy than the lower m/z ions as the higher m/z ions experience the extraction field over a longer temporal period.

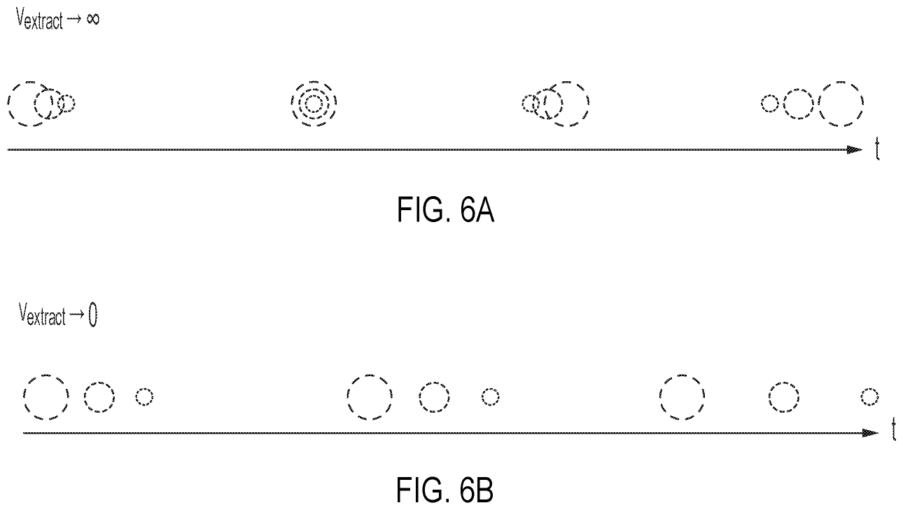

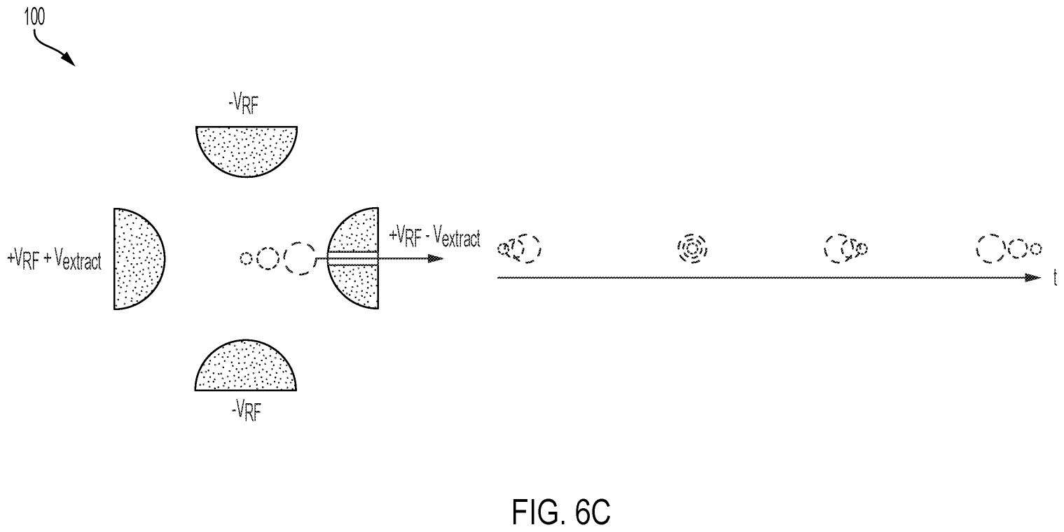

With reference to FIG. 6A, in the limit of the extraction field approaching infinity, the kinetic energy difference between the higher and the lower m/z ions will be sufficient to impart to the higher m/z ions a larger velocity than the lower m/z ions, thus causing the ejected ion packet to converge at a time/distance that is proportional to the magnitude of the dipolar DC voltage pulse and the extraction field.

In contrast, as shown schematically in FIG. 6B, in the limit of the extraction field approaching zero, the kinetic energy difference between the high and low m/z ions will be too small to impart to high m/z ions a larger final velocity than the low m/z ions and hence the spatial separation between the ejected ions will continue to expand, yielding a limited m/z range in the downstream analyzer.

Considering these two limits, the m/z focal distance (i.e., the distance at which the ions exiting the trap at different times catch up with one another) can be tuned by changing the magnitude of the dipolar DC voltage pulse and/or the extraction field. Such tuning can take into account that the theoretical distance between the ion trap 100 and a downstream ELIT can often be very different from the realized focal length due to additional ion optical elements/voltages that may be necessary for efficient ion transfer.

FIG. 6C shows in turn a dipolar DC potential, where the voltage applied to the electrode 102d is more negative than the voltage applied to the electrode 102c, such that upon extraction, the ions are ordered from large m/z to small m/z.

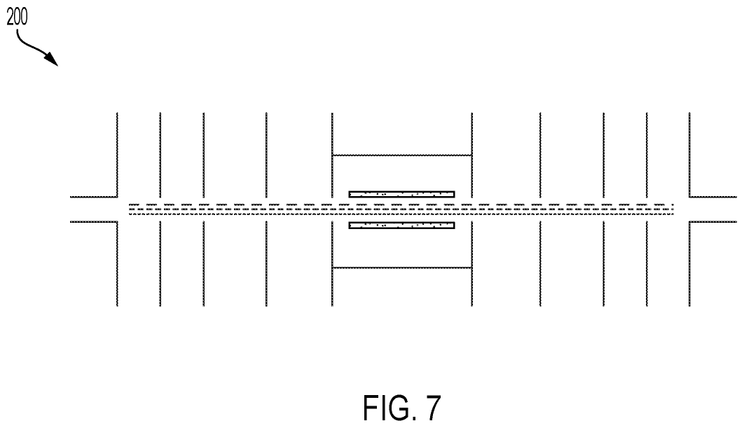

More specifically, with reference to FIG. 7, similar to the previous embodiment, the ELIT 200 can receive the ions ejected from the upstream ion trap 100. Due to their higher kinetic energy, in this embodiment, the high m/z ions (depicted with long dashes) penetrate more deeply through the ion mirrors of the ELIT 200 than the lower m/z ions (depicted with short dashes). That is, the turning point for high m/z ions within each of the ion mirrors 202/204 is located farther than the respective turning point for low m/z ions.

The detection of the ions and the generation of a mass spectrum thereof can be achieved in a similar manner as that discussed above in connection with the previous embodiment.

Again, the variation in the location of the turning points as a function of m/z ratios of the ions can advantageously reduce the charge density and associated space charge effects near the turning points.

Such advantageous spatial broadening of the turning points is not typically realized in conventional systems in which electrostatic traps, such as an Orbitrap, are employed because in such conventional systems the radial injected kinetic energy is decoupled from the axial energy of the ions. In many embodiments, the present teachings can provide the added advantage of reducing the space charge density, and hence space-charge effects, within the multipole (e.g., quadrupole) ion trap itself prior to radial extraction of the ions from the ion trap, e.g., as a result of the mass-ordered radial separation of the ions caused via application of the dipolar DC voltage pulse, as discussed above.

Further, normally, using a dipolar DC voltage in a quadrupole ion trap can lead to RF heating of all ion populations (i.e., ions having different m/z ratios) and can induce ion fragmentation, though such fragmentation generally requires the residence of the ions in the ion trap for tens to hundreds of milliseconds at low pressure (among other parameters, the time required depends on the selected low-mass cutoff, where the time required depends on the set low mass cutoff). In contrast, in various embodiments of the present teachings, the ions can be ejected from the ion trap after tens of microseconds, thus reducing the risk of fragmentation. In particular, in the embodiments of the present teachings, once the ions are moved off-axis via the application of a dipolar voltage pulse and are stabilized, the ions can be ejected. As there is no need for ion fragmentation, in such embodiments the ions can be extracted over a much shorter time period.

Although in the above embodiments the ejection of the ions from the ion trap is achieved via a push-pull extraction, in other embodiments a pull or a push extraction alone can also be employed. In some embodiments, only a pull or only a push extraction can be achieved, for example, by maintaining one of the electrodes of two opposed electrodes in one of which a channel for extraction of ions is provided at the rod offset potential while applying an extraction voltage (e.g., an attractive extraction voltage in the case of a pull extraction and a repulsive extraction voltage in the case of a push extraction) to the opposed electrode. In some embodiments, just prior to the ejection of the ions from the ion trap (which in some cases can last 100's of nanoseconds), the RF signals applied to the rods can be rapidly deenergized.

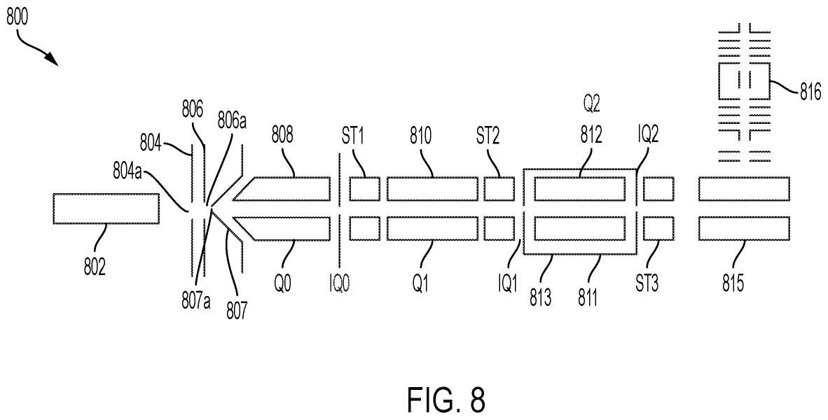

An ion trap according to the present teachings can be incorporated in a variety of mass spectrometers. By way of example, FIG. 8 schematically depicts such a mass spectrometer 800, which includes an ion source 802 for generating a plurality of ions. A variety of ion sources can be employed in the practice of the present teachings. Some examples of suitable ion sources can include, without limitation, an electrospray ionization device, a nebulizer assisted electrospray device, a chemical ionization device, a nebulizer assisted atomization device, a chemical ionization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, among others.

The generated ions pass through an orifice 804a of a curtain plate 804 and an orifice 806a of an orifice plate 806, which is positioned downstream of the curtain plate and is separated from the curtain plate such that a gas curtain chamber is formed between the orifice and the curtain plate. A curtain gas supply (not shown) can provide a curtain gas flow (e.g., of N₂) between the curtain plate 804 and the orifice plate 806 to help keep the downstream sections of the mass spectrometer clean by declustering and evacuating large neutral particles. The curtain chamber can be maintained at an elevated pressure (e.g., a pressure greater than the atmospheric pressure) while the downstream sections of the mass spectrometer can be maintained at one or more selected pressures via evacuation through one or more vacuum pumps (not shown).

In this embodiment, the ions then pass through an orifice 807a of a skimmer 807 to be received by an ion guide Q0, which comprises four rods 808 (two of which are visible in this figure) that are arranged in a quadrupole configuration to form an ion beam for transmission to downstream components of the mass spectrometer.

The ion beam exits the Q0 ion optic and is focused via an ion lens IQ0 and a stubby lens ST1 into a subsequent ion mass analyzer Q1, which includes four rods 810 (two of which are visible in this figure) that are arranged in a quadrupole configuration and to which RF voltages as well as a DC resolving voltage can be applied for radially focusing the ions and selecting ions having a target m/z ratio (herein referred to as precursor ions) as they pass through the Q1 mass analyzer. In other embodiments, other multipole configurations, such as a hexapole or an octupole configuration, can be utilized. In some embodiments, the pressure of the Q1 mass analyzer can be maintained, for example, in a range of about 3 mTorr to about 10 mTorr.

More specifically, in this embodiment, the quadrupole rod set Q1 can be operated as a conventional transmission RF/DC quadrupole mass filter for selecting ions having an m/z value of interest or m/z values within a range of interest. By way of example, the quadrupole rod set Q1 can be provided with RF/DC voltages suitable for operation in a mass-resolving mode. For example, parameters of applied RF and DC voltages can be selected so that Q1 establishes a transmission window of chosen m/z ratios, such that these ions can traverse Q1 largely unperturbed. Ions having m/z ratios falling outside the window, however, do not attain stable trajectories within the quadrupole and can be prevented from traversing the quadrupole rod set Q1. It should be appreciated that this mode of operation is but one possible mode of operation for Q1.

The ions passing through the Q1 mass analyzer are focused via a stubby lens ST2 and an ion lens IQ1 into a collision cell Q2. The collision cell Q2 includes four rods 812 (two of which are visible in this figure) that are arranged in a quadrupole configuration and to which RF voltages can be applied for providing radial confinement of ions. The rods 812 are disposed within an enclosure 813 such that the pressure within the collision cell can be increased relative to the other stages, e.g., via introduction of a gas (e.g., nitrogen) into the enclosure, to facilitate collisional fragmentation of at least some of the ions via collisions with the background gas, thereby generating a plurality of product ions.

The generated product ions are guided via an ion lens IQ2 and a stubby lens ST3 into an ion trap 815 according to the present teachings, which can be implemented in a manner discussed above. An ELIT 816 is disposed downstream of the ion trap 815 to receive the ions ejected from the ion trap 815 and generate ion detections signals, which can be analyzed by an analyzer (not shown in this figure), in a manner discussed above, to generate a mass spectrum of the product ions.

Those having ordinary skill in the art will appreciate that various changes can be made to the above embodiments without departing from the scope of the present teachings.

What is claimed is:

1. A mass spectrometer, comprising:
an ion trap, comprising:
a plurality of electrodes arranged in a multipole configuration so as to provide an inlet for receiving ions along a longitudinal axis into a space between said electrodes, at least one of said plurality of electrodes comprising a passageway through which ions can be extracted radially from said ion trap,
said electrodes being configured for application of one or more RF voltages thereto for providing radial confinement of said ions, and
at least one DC voltage source configured to apply a dipolar DC voltage pulse across said at least one electrode and an opposed electrode for causing radial offset of at least a portion of the ions relative to said at least one of said plurality of electrodes.

2. The mass spectrometer of claim 1, wherein said at least one DC voltage source is configured to apply a DC extraction voltage to radially offset ions to cause transmission of at least a portion of said ions through said passageway out of the ion trap.

3. The mass spectrometer of claim 1, further comprising an electrostatic linear ion trap (ELIT) positioned downstream of said ion trap for receiving at least a portion of the ions extracted from said ion trap.

4. The mass spectrometer of claim 3, wherein said ELIT comprises at least two ion mirrors each of which is disposed at one end of said ELIT for axially trapping the received ions in a space therebetween.

5. The mass spectrometer of claim 4, wherein said ELIT further comprises an electric charge detector disposed between said two ion mirrors for detecting said ions.

6. The mass spectrometer of claim 5, wherein said electric charge detector comprises a substantially cylindrical electrode surrounding at least a portion of said space between the ion mirrors such that passage of the ions through said cylindrical electrode induces electric charge on said cylindrical electrode, thereby generating one or more ion detection signals.

7. The mass spectrometer of claim 6, further comprising a detection circuit in communication with said electric charge detector for generating one or more detection signals based on said induced electric charge.

8. The mass spectrometer of claim 7, further comprising an analysis module in electrical communication with said detection circuit for receiving said one or more ion detection signals and operating on said ion detection signals to generate a mass spectrum of the ions received by said ELIT.

9. The mass spectrometer of claim 8, wherein said analysis module is configured to apply Fourier transform to said one or more ion detection signals so as to generate the mass spectrum of the ions received by the ELIT.

10. The mass spectrometer of claim 1, wherein said dipolar voltage pulse causes a substantially mass ordered radial separation of the ions in said ion trap.

11. The mass spectrometer of claim 10, wherein said extraction voltage causes a difference in kinetic energy of the ions extracted from the ion trap such that said extracted ions arrive substantially concurrently at a downstream electrostatic linear ion trap (ELIT).

12. The mass spectrometer of claim 11, wherein a polarity of said dipolar voltage pulse is selected such that the ions are extracted from the ion trap in a high mass to low mass order.

13. The mass spectrometer of claim 12, wherein said dipolar voltage pulse imparts more kinetic energy to lower mass ions relative to higher mass ions such that said ions arrive substantially concurrently at said downstream ELIT.

14. The mass spectrometer of claim 11, wherein a polarity of said dipolar voltage pulse is selected such that the ions are extracted from the ion trap in a low mass to high mass order.

15. The mass spectrometer of claim 14, wherein said dipolar voltage pulse imparts more kinetic energy to higher mass ions relative to lower mass ions such that said ions arrive substantially concurrently at said downstream ELIT.

16. The mass spectrometer of claim 1, wherein said multipole configuration comprises a quadrupole configuration.

17. The mass spectrometer of claim 1, wherein said one or more RF voltages have a frequency in a range of 0.1 MHz to about 5 MHz.

18. The mass spectrometer of claim 1, wherein said one or more RF voltages have an amplitude in a range of about 100 volts to about 1000 volts.

19. The mass spectrometer of claim 1, wherein said dipolar voltage pulse has an amplitude in a range of about 25 volts to about 500 volts.

20. A method of performing mass spectrometry, comprising:
introducing a plurality of ions into an ion trap comprising a plurality of electrodes arranged in a multipole configuration, wherein one of said electrodes comprises a passageway for radial extraction of the ions from the ion trap,
applying one or more RF voltages to one or more of said electrodes to generate an electromagnetic field for radially confining said ions within the ion trap,
applying a DC dipolar voltage pulse across said electrode having the passageway and an opposed electrode so as to cause radial offset of said ions relative said electrode having said passageway, and
subsequently, applying an extraction voltage to said ions so as to cause extraction of at least a portion of said ions from said ion trap.

21. The method of claim 20, wherein a polarity of said DC dipolar voltage pulse is selected such that the ions are offset relative to said electrode having the passageway in a high to low mass order, and optionally,
wherein a polarity of said DC dipolar voltage pulse is selected such that the ions are offset relative to said electrode having the passageway in a low to high mass order.

22. The method of claim 20, further comprising directing at least a portion of said extracted ions to a downstream electrostatic linear ion trap (ELIT).

23. The method of claim 22, further comprising axially trapping the ions introduced into the ELIT.

24. The method of claim 23, further comprising utilizing an electric charge detector incorporated in said ELIT for detecting said axially trapped ions.
